(19) United States
(12) Patent Application Publication
(10) Pub. No.: US 2010/0247702 A1
(43) Pub. Date: Sep. 30, 2010

(54) SYSTEMS AND METHODS FOR A CONTROLLED PROCESS FOR PRODUCING MIXTURES OF LIGHTWEIGHT CONSTRUCTION MATERIALS AND SYSTEMS FOR AUTOMATIC PRODUCTION OF LIGHTWEIGHT BRICKS

(75) Inventor: Gilbert Gal Ben Lulu, Ashdod (IL)

Correspondence Address: ARENT FOX LLP, 1050 CONNECTICUT AVENUE, N.W., SUITE 400, WASHINGTON, DC, 20036, US

(73) Assignee: Rompypaz Engineering Ltd.

(21) Appl. No.: 12/600,305

(22) PCT Filed: Mar. 27, 2008
(86) PCT No.: PCT/IL08/00422

§ 371 Date: May 12, 2010

Related U.S. Application Data
(60) Provisional application No. 60/917,682, filed on May 14, 2007.

(51) Int. Cl. B29C 41/42; G06F 19/00

(52) U.S. Cl. 425/255; 700/265

(57) ABSTRACT

A system for producing ready-to-use mixtures of lightweight construction materials is provided. The system includes a subsystem for mixing and controlling the dry construction materials, a subsystem for mixing and controlling the additive materials, a main mixer which produces the ready-to-use mixture of lightweight construction material and a computerized control unit which controls the manufacturing process and thereby producing a ready-to-use mixture of lightweight construction material which is substantially uniform and has a controlled specific gravity. The present invention further provides an automated line of production for manufacturing ready-to-ship porous lightweight brick walls, controlled by the computerized control unit

### FIELD OF THE INVENTION

The present invention relates to a porous lightweight construction material, and more particularly, the present invention relates systems and methods for the manufacturing of lightweight construction materials, including lightweight concrete, used to manufacture porous lightweight brick walls, pavements and other constructions, the system including a mixer capable of mixing ready-mix mortar with a foamy mixture of polymeric and chemical catalysts, and a control unit for controlling and monitoring the materials used and their measured quantity.

### BACKGROUND OF THE INVENTION

In prior art system for producing a lightweight mixture for molding porous brick walls, pavements and other construction products, the mixing of the materials is done manually with no accurate control on the quantities used and on the uniformity of the mixture product.

In one prior art method for producing porous brick walls, a big mixer is used to first produce an aluminum based foamy mixture of materials such as monocalcium aluminate and Mayenite, which may include cement and may not. The mixture also includes lime/Calcium Silicate which reaction forms a cake mixture that is cut into bricks form. The bricks are than baked in a steam oven in about 200° C. and under a pressure of about 10 bars for 8 hours, including 2 hours of gradually rising temperature and 2 hours of gradually lowering the temperature. The baked bricks are then left to cool down, wrapped with materials that preserve humidity such as plastic, for about 24 hours. The method is an energy intense process, and suffers from a low yield due to cake crumbling and cracking bricks.

In another prior art method for producing porous brick walls, a large mixer (typically 9 m³) is used to first produce a cement based foamy mixture of materials, which is poured into individual mold for producing individual bricks. Soap is added to the mixture to form air bubbles in the mixture, to reduce weight. The process is not controlled including the uniformity of the mixture, the quantity of the bubbles, the water temperature, etc. Typically sample of the mixtures are taken to measure the mixture specific gravity. The system has low yield and low economic efficiency.

The strength of the brick is determined, among other things, by the quantity of water used to create the brick and the volume and density of air pockets. Typically, prior art systems use about 50 liters of water per 100 Kg of cement. The quantity of water used determines the reaction rate of the hardening of the mixture.

Thus there is a further need for and it would be advantageous to have system for the manufacturing of lightweight construction materials, that uses less water in the curing/hardening process and thereby produce a stronger brick.

There is a further need for and it would be advantageous to have system for the manufacturing of lightweight construction materials, including lightweight concrete, used to manufacture porous lightweight brick walls, pavements and other constructions, the system including a mixer capable of mixing ready-mix mortar with a foamy mixture of polymeric and chemical catalysts, and a control unit for controlling and monitoring the process and the materials used, and their measured quantity.

Thus there is a further need for and it would be advantageous to have an automated line of production for mass producing ready-to-ship porous lightweight brick walls from ready-to-use mixtures of lightweight construction materials, freshly produced by the controlled automatic system for the manufacturing of lightweight construction materials.

The term “curing”, as it relates to concrete and to construction materials including lightweight concrete, is used herein refers to a process where the cement in concrete is allowed to react with the water over time, increasing the concrete's strength and hardness. The reaction of the cement with water generates heat which should not surpass 70° C. to prevent the cracking of the concrete formed. It should be noted that coal fly ash also reacts with water and when added to cement, coal fly ash allows lower concrete water content, early strength can also be maintained.

### SUMMARY OF THE INVENTION

The principle intention of the present invention includes providing systems and methods for manufacturing lightweight construction materials, including lightweight concrete, used to manufacture porous lightweight brick walls, pavements and other constructions, the system including a mixer capable of mixing ready-mix mortar with a foamy mixture of polymeric and chemical catalysts, and a control unit for controlling and monitoring the process and the materials used, and their measured quantity.

According to the teachings of the present invention there is provided a system for manufacturing ready-to-use mixture of lightweight construction material, the system includes:
(a) one or more containers containing dry construction materials;
(b) a mechanism for moving the dry construction materials;
(c) one or more containers containing additive materials controllably added to the mixture of lightweight construction material;
(d) a water supply subsystem;
(e) a pressured air supplying unit;
(f) a foaming canon;
(g) a moistening unit;
(h) a main mixer; and
(i) a computerized control unit.
   wherein pre measured quantities of the dry construction materials are mixed and pushed into the moistening unit and pre measured amount of water are also propagated into the moistening unit. The dry construction materials and the water are then mixed together by the moistening unit, thereby producing wet mortar having a controlled amount of moisture;
   wherein pre measured quantities of the additive materials are propagated into the line of water for the foaming canon and pre measured amount and pressure of air is also propelled into the foaming canon. The additive materials and the air are mixed together by the foaming canon, thereby producing a controlled foam having controlled quantity and size of air bubbles; and
   wherein pre measured quantities of the wet mortar and pre measured quantities of the controlled foam are propelled into the main mixer thereby producing the ready-to-use mixture of lightweight construction material, having a controlled temperature, a controlled specific gravity and a substantially uniform texture.

The dry construction materials are selected from the group including: cement, coal fly ash, ground sand and other dry construction materials or a mixture thereof.

The additive materials are selected from the group including: cement hardening catalyst materials, detergents, polymers and other additive materials. In embodiments of the present invention, one of the polymer additives is Styrene Butadiene Rubber (SBR). In embodiments of the present invention, one of the cement hardening catalyst materials is Calcium Chloride.

The control unit enables a fully automatic production of the ready-to-use mixture of lightweight construction materials, controlling various system parameters, wherein the parameters are selected from a group including: the quantity of materials in one or more of the containers, the temperature volume and flow rate of the water channeled to the moistening unit, the temperature volume and flow rate of the water channeled to the foaming canon the pressure and volume of the air propelled into the foaming canon, the volume and flow rate of each of the dry construction materials, the volume and flow rate of each of the additive materials, the volume and flow rate of the wet mortar, the volume and flow rate of the controlled foam.

An aspect of the present invention is to provide a detergent that enables the formation of air bubbles in the ready-to-use mixture of lightweight construction material. The water supply subsystem comprises a water tank and/or water storage with heating device, wherein the heating energy used by the water heating device is selected from the group including electric, solar, fuel, any other source of energy. It should be noted that the water tank that supplies water to the system and can be replaced by any water source.

In embodiments of the present invention one or more material ingredients are added from a post mixer container to the mixture of lightweight construction material flowing out of the main mixer. Typically, the post mixer container contains fibers, which are added to the poring mixture, for example, polypropylene fibers.

The present invention further teaches that the control unit further controls a bricks production line for producing lightweight construction bricks from the ready-to-use mixture of lightweight construction material. The production line including a first station for placing a pallet; a second station for assembling a substantially parallelepiped mold, wherein the pallet is disposed at the bottom of the mold and thereby substantially sealing the bottom of the mold; a third station for filling the mold with the mixture of lightweight construction material; a forth station, typically including multiple sub stations, for curing the mixture of lightweight construction material to create a hardened parallelepiped lightweight construction body; a fifth station for disassembling the mold from the hardened parallelepiped lightweight construction body; a sixth station for cutting the hardened parallelepiped lightweight construction body into lightweight construction bricks; and a final station for removing the pallet with the lightweight construction bricks from the production line. Preferably, the production line further includes a wrapping station for wrapping the lightweight construction bricks with wrapping material, allowing the bricks a final curing process. The production line further includes a mechanism for assembling the mold at the second station; another or the same mechanism for disassembling the mold at the fifth station; another or the same mechanism for transferring the disassembled mold from the fifth station to the second station; and a mechanism for removing the pallet with the wrapped/unwrapped lightweight construction bricks from the production line, at the final station.

In embodiments of the present invention, the second station and the third station are the same station, wherein the filling of the mold with the ready-to-use mixture of lightweight construction material is performed after the assembly of the mold.

In embodiments of the present invention, the forth station is one or more stations for controlling the curing process of the lightweight construction material.

In embodiments of the present invention, the sixth station is one or more stations for cutting the hardened parallelepiped lightweight construction body.

An aspect of the present invention is to provide a substantially parallelepiped mold comprising four walls; a mechanism for locking the four walls together when assembling the mold at the second station, and thereby substantially sealing the four walls; and a mechanism for unlocking the four walls when disassembling the mold at the fifth station, without damaging the hardened parallelepiped lightweight construction body. Preferably, the mold assembly and disassembly mechanisms are the same mechanism, being a moving crane. Preferably, the crane is also used for transferring the disassembled mold from the fifth station to the second station.

An aspect of the present invention is for the control unit to also control the curing process for hardening the lightweight construction material, preventing the cracking of the lightweight construction bricks, and the scheduling of activities at each of the stations.

An aspect of the present invention is to provide a process for producing porous lightweight brick walls, which uses less water less water in the hardening process and thereby produce a stronger brick. Typically, the process uses about half the amount of water prior art systems for producing porous lightweight brick walls use. The use of less water substantially reduces the amount of energy needed to operate the system of the present invention for producing a lightweight mixture for molding porous brick walls.

The total number of stations, including sub-stations, in the production line is designed according to the volume of lightweight construction bricks produced.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 illustrates a system for producing ready-to-use uniform mixtures of lightweight construction materials, according to embodiments of the present invention;

FIG. 2 illustrates the subsystem controlling the dry construction materials of the system shown in FIG. 1;

FIG. 3 illustrates the subsystem controlling the additive materials of the system shown in FIG. 1;

FIG. 4 illustrates the main mixer for mixing the dry construction materials and the additive materials of the system shown in FIG. 1;

FIG. 5 illustrates an example line of production for producing ready-to-ship porous lightweight brick walls, according to embodiments of the present invention;

FIG. 6 illustrates the assembly of an example cart and pallet for conveying the lightweight bricks being manufacture in the production line shown in FIG. 5;

FIG. 7 illustrates the cart shown in FIG. 6, assembled;

FIG. 8 illustrates an example mold for producing ready-to-ship porous lightweight brick walls, according to embodiments of the present invention;

FIG. 9 illustrates an example locking and sealing mechanism of the walls of the mold shown in FIG. 8;

FIG. 10 illustrates a top view illustration of the mold shown in FIG. 8, the mold being in a locked state;

FIG. 11 illustrates a top view illustration of the mold shown in FIG. 8, the mold being in an open state;

FIG. 12 illustrates cross section AA′ of the mold shown in FIG. 8, the mold being in a locked state; and

FIG. 13 illustrates cross section BB′ of the mold shown in FIG. 8, the mold being in an open state.

### DETAILED DESCRIPTION OF THE INVENTION

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

In embodiments of the present invention a system for producing ready-to-use mixtures of lightweight construction materials is provided. The system includes a subsystem for mixing and controlling the dry construction materials, a subsystem for mixing and controlling the additive materials, a main mixer which produces the ready-to-use mixture of lightweight construction material and a computerized control unit which controls the manufacturing process and thereby producing a ready-to-use mixture of lightweight construction material which is substantially uniform and has a controlled specific gravity.

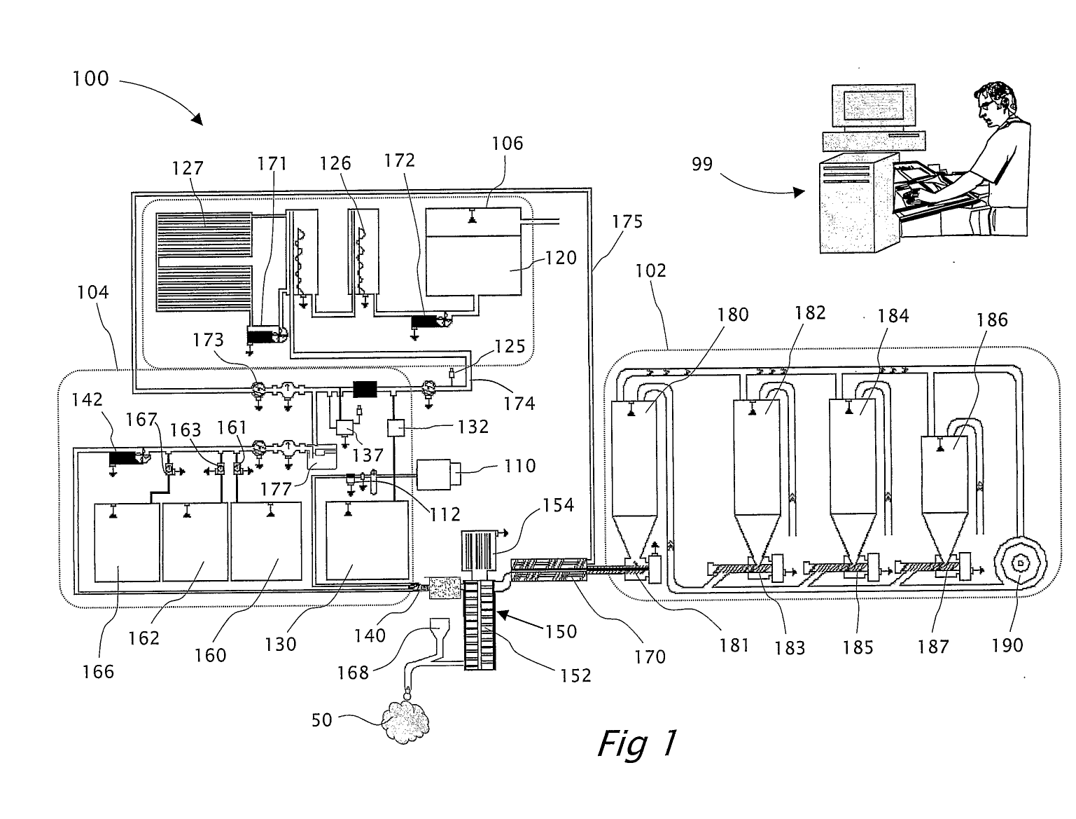

Reference is now made to the drawings. FIG. 1 illustrates mixing system 100 for producing ready-to-use uniform mixtures 50 of lightweight construction materials, according to embodiments of the present invention. System 100 includes:
(a) one or more containers (180, 182, 184, 186) containing dry construction materials;
(b) a mechanism for moving the dry construction materials;
(c) one or more containers (130, 134, 160, 165) containing additive materials controllably added to the mixture of lightweight construction material;
(d) water tank 120;
(e) pressured air supplying unit 110;
(f) foaming canon 140;
(g) moistening unit 170;
(h) main mixer 150; and
(i) computerized control unit 99.

### The Subsystem for Mixing and Controlling the Dry Construction Materials

In subsystem 102 for mixing and controlling the dry construction materials, pre measured quantities of dry construction materials are mixed and pushed into moistening unit 170. Simultaneously, a pre measured amount of water having a controlled temperature, are propagated into moistening unit 170. Then, the dry construction materials and the water are mixed together by moistening unit 170, thereby producing wet mortar having a controlled amount of moisture. The wet mortar is then conveyed into main mixer 150.

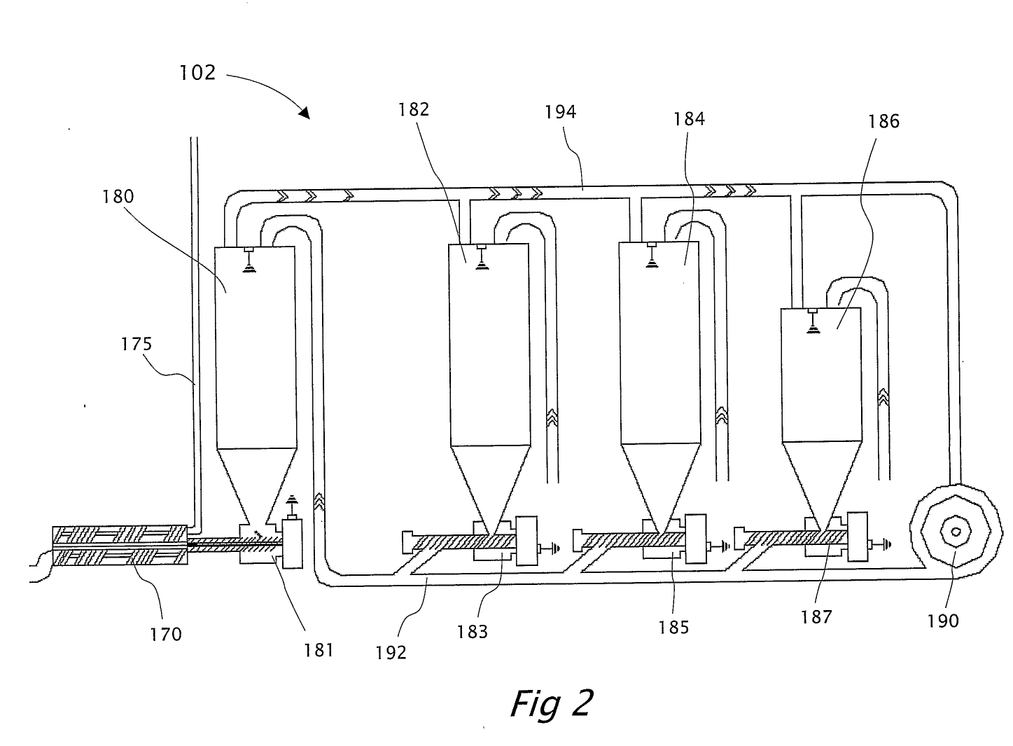

Reference is also made to FIG. 2, which illustrates the dry construction materials subsystem 102 of system 100. Subsystem 102 includes one or more containers (180, 182, 184, 186) containing the dry construction materials and a mechanism for moving the dry construction materials towards main mixer 150. Typically, container 180 includes a substantially uniform mixture of dry construction materials that were moved into container 180 by the mechanism for moving the dry construction materials. The other containers (182, 184, 186) include various dry construction materials, selected from the group including: cement, coal fly ash, ground sand and other dry construction materials, or a mixture thereof. Containers (180, 182, 184, 186) are typically silos, each having a mechanism (181, 183, 185, and 187, respectively) at the bottom of the silo (180, 182, 184, 186) that conveys a controlled amount the material moved out of the respective silo. Typically, subsystem 102 is a closed circled system, having a pushing mechanism, such as blower 190, that blows air (or other gas) into pipe 192, whereas the pressured air push the dry construction materials through pipe 192 towards silo 180 were the dry construction materials are mixed into a substantially uniform mixture. The pressured air is returned through returning pipe 194. Each conveying mechanism (181, 183, 185, 187,) enables control unit 99 to control the amount of dry construction material conveyed out of the respective silo. It should be noted the blower 190 is given by way of example only and other pushing mechanism such as a progressive cavity pump.

The substantially uniform mixture is conveyed out of silo 180 by conveying mechanism 181 into moistening unit 170. Simultaneously, a pre measured amount of water having a controlled temperature, are propagated through pipe 175 into moistening unit 170. Moistening unit 170 mixes the dry construction materials and the water together, thereby producing wet mortar having a controlled amount of moisture and a controlled temperature.

The Subsystem for Mixing and Controlling the Additive Materials into Foam

In subsystem 104 for mixing and controlling the additive materials, pre measured quantities of additive materials are propagated into foaming canon and pre measured amount and pressure of air is propelled into the foaming canon 140, and wherein the additive materials and the air are mixed together by foaming canon 140, thereby producing a controlled foam having controlled quantity and size of air bubbles. The foam is then conveyed into main mixer 150.

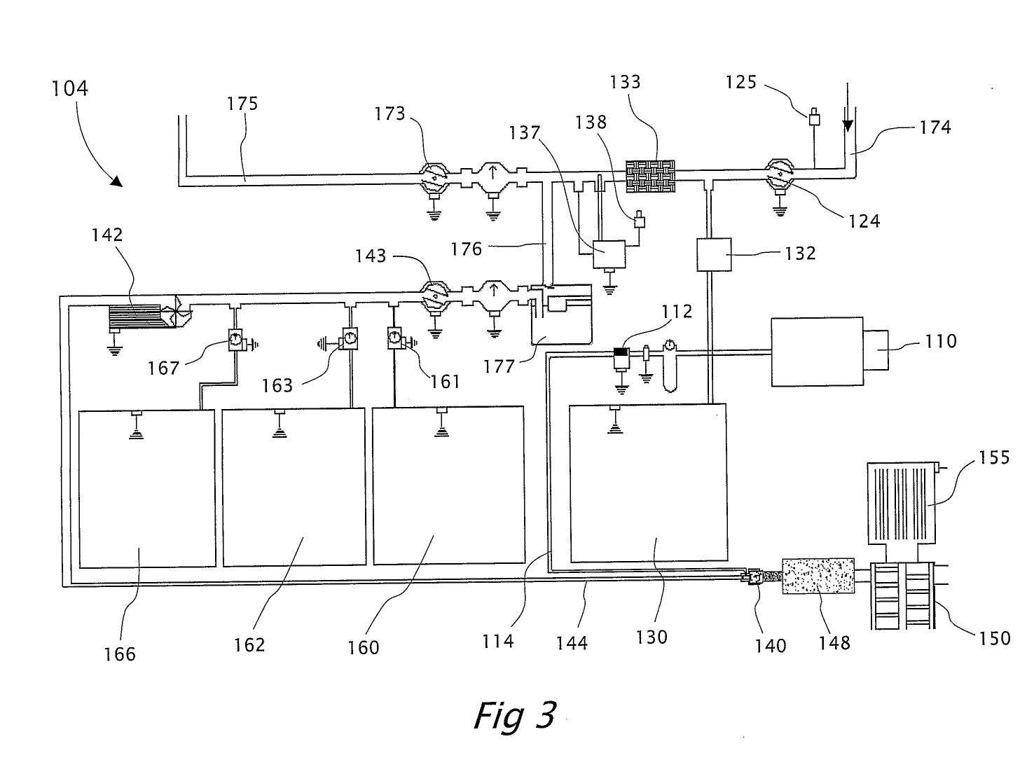

Reference is also made to FIG. 3, which illustrates the additive materials subsystem 104 of system 100. Subsystem 104 includes one or more containers (134, 130, 160, 165) containing additive materials and a mechanism for controllably propagating the additive materials towards foaming canon 140. The additive materials are conveyed by water having controlled temperature, coming from the water supply subsystem 106. Water supply subsystem 106 includes a water tank 120, a water heating and storage device and monitoring and controlling units connected to control unit 99, which operatively controls the heat of the water supplied by water supply subsystem 106. The water heating and storage device can be a boiler 126, or a solar system 127, a fuel operated device or any other device capable of storing and heating water. The heat of the water coming from the water supply subsystem 106 is monitored, for example by sensor 125 and the flow of the water coming from the water supply subsystem 106 is controlled by flow control unit 124. It should be noted that water tank 120 can be replaced by any water source such as public water supply network or any other water source.

A first type of additive materials is cement hardening catalyst materials, such as Calcium Chloride. The cement hardening catalyst material is added to water pipe segment 174 thereby the water propagated both to moistening unit 170, via pipe 175, and to foaming canon 140, via pipe 176, preferably contains the hardening catalyst material. The amount of cement hardening catalyst material extracted from container 130 is controlled by pump 132, operatively controlled by computerized control unit 99. The cement hardening catalyst material is mixed in the flowing water be mixer 133, and control unit 99 monitors the PH in the water, the ambient temperature and other parameters using monitoring unit 137.

Other additive materials are typically added to water pipe segment 176 propagated the water to foaming canon 140. Preferably, pipe segment 176 is separated from pipe segment 175 by intermediate water tank 177, which enables pipe segment 176 and pipe segment 175 to operate at different internal pressure.

A second type of additive materials are detergent materials, such as soap, for forming the air bubbles in the mixture, and thereby changing the specific gravity of the produced ready-to-use mixture of lightweight construction material. The amount of detergent extracted from container 160 is controlled by pump 161, operatively controlled by computerized control unit 99.

Optionally, other additives are added to the water mixture being propagated to foaming canon 140. For example, container 162 contains polymers, such as Styrene Butadiene Rubber (SBR). The amount of polymers extracted from container 162 is controlled by unit 163, operatively controlled by computerized control unit 99.

Optionally, other additives are added to the water mixture being propagated to foaming canon 140, contained in one or more containers 166 and controlled by unit 167, operatively controlled by computerized control unit 99.

Optionally, cement hardening delay materials are also added to water pipes 174 and/or 176 to counter balance the effect of the cement hardening catalyst material. The amount of cement hardening delaying materials is operatively controlled by computerized control unit 99.

The flow of water in pipe 174, propagating the water to moistening unit 170, is operatively monitored and controlled by computerized control unit 99 using flow control unit 173 and pumps 171 and/or 172. The flow of water in pipe 176, propagating the water to foaming canon 140, is operatively monitored and controlled by computerized control unit 99 using flow control unit 143 and pump 142.

Pressured air supplying unit 110 provides the air required to form the air bubbles in the formed foam. The flow of air is operatively monitored and controlled by computerized control unit 99 using flow control unit 112. The pressured air is propagated to foaming canon 140 along with the water containing the additive materials.

Foaming canon 140 forcefully injects the water containing the additive materials provided in pipe 176 and the pressured air provided in pipe 114 into foaming stabilizer 148. Uniform foam is formed, whereas the foaming process is controlled and monitored by control unit 99, wherein the parameters being controlled include the apportionment of each ingredient and the bubbles size, quantity and density.

### The Main Mixer

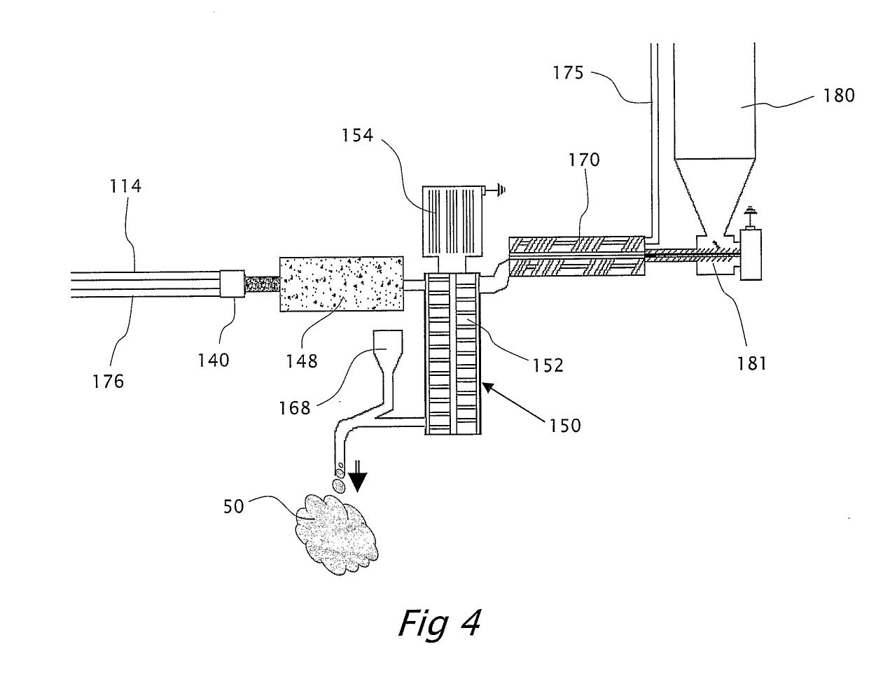

Reference is also made to FIG. 4, which illustrates main mixer 150 for mixing the dry construction materials and the additive materials of system 100. Main mixer 150 mixes together the wet mortar provided by moistening unit 170 and the foam provided by foaming canon 140, whereas the ratio between the wet mortar and the foam and the pressure at which the foam is injected into mixer 150 being pressurized into mixer 150 are controlled by control unit 99. Main mixer 150 includes a motor 154 and a blender 152, motor 154 being controlled by control unit 99. Blender 152 can be embodied in any mechanism, for example a spiral mechanism, which blends all the ingredients to obtain a substantially uniform mixture. Main mixer 150 provides the system product being a ready-to-use mixture of lightweight construction material 50 which is substantially uniform and has a controlled specific gravity. The specific gravity is controlled by the total volume of the air bubbles in mixture 50, whereas the more air bubbles are created the lower the specific weight/gravity of mixture 50 is.

It should be noted that the ratio between the wet mortar and the foam determines the specific weight/gravity of outcome mixture 50, and thereby the weight/gravity of the final product, such as a porous lightweight brick wall.

### A Line of Production for Producing Ready-to-Ship Lightweight Brick Walls

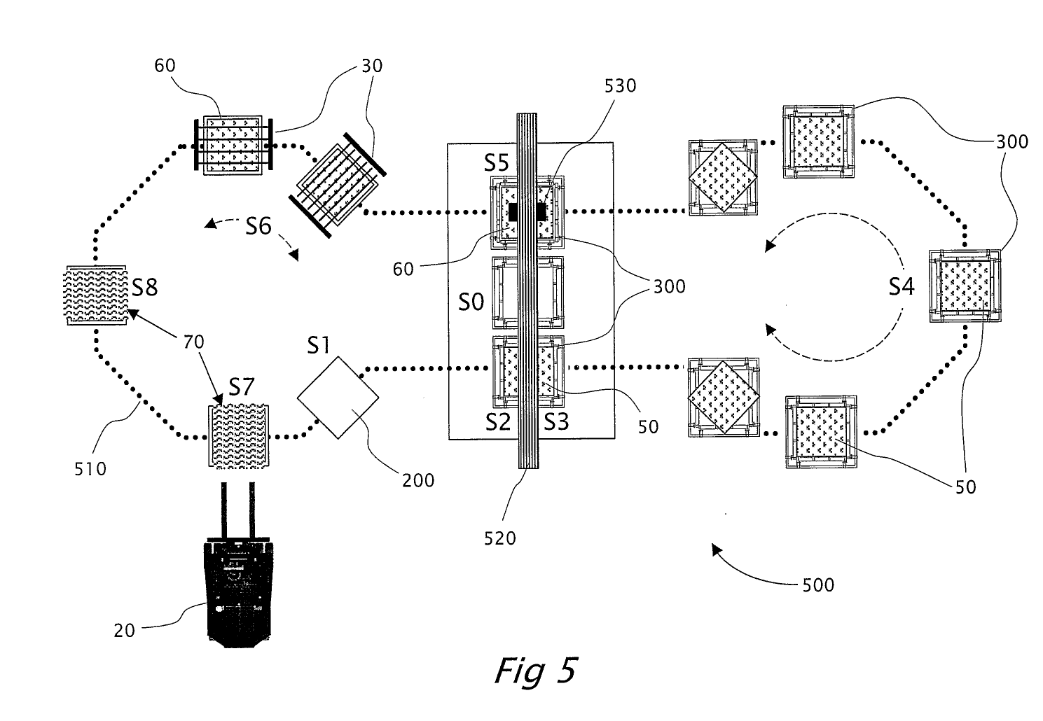

FIG. 5 illustrates an example line of production 500 for producing ready-to-ship porous lightweight brick walls, according to embodiments of the present invention. Production line 500 for producing ready-to-ship lightweight brick walls is an automated, closed loop production line. The ready-to-ship porous lightweight brick walls are manufactured from mixture 50 of lightweight construction material. Production line 500 includes the following stations located at various locations on path 510:
(a) first station S1 for placing pallet 200;
(b) second station S2 for assembling a substantially parallelepiped mold 300, wherein mold 300 is opened at the bottom and top, and wherein pallet 200 is disposed at the bottom of mold 300 and thereby substantially sealing the bottom of mold 300;
(c) third station S3 for filling mold 300 with ready-to-use mixture 50 of lightweight construction material, whereas in the preferred embodiment of the present invention, station S3 and station S2 are the same station, and wherein the filling of mold 300 with mixture 50 is performed after the assembly of mold 300.
(d) forth station S4 for ready-to-use mixture 50 of lightweight construction material to complete the chemical reaction and thereby hardening lightweight construction material 50 to create hardened parallelepiped lightweight construction body 60;
(e) fifth station S5 for disassembling mold 300 from hardened parallelepiped lightweight construction body 60;
(f) sixth station S6 for cutting hardened lightweight construction body 60 into lightweight construction bricks; and
(g) final station S7 for removing pallet 200 with the lightweight construction bricks from production line 500, for example by a forklift 20.

Forth station S4 of production line 500 includes one or more stations for controlling the chemical reaction and thereby controlling the curing process lightweight construction material 50. It should be noted that the temperature of mixture 50 should not surpass 70° C. to prevent the cracking of the hardened lightweight construction material 50.

Fifth station S5 includes a sensor for measuring the temperature of the arriving hardened parallelepiped lightweight construction body 60. Control unit 99 analyzes the measured temperature, to determine if a change in parameters affecting the curing process is required. If, for example, the measured reaction temperature is higher than a predetermined threshold temperature, control unit 99 can change one or more of the following parameters:

(a) shorten to curing duration;

(b) reduce the water temperature;

(c) reduce the quantity of cement hardening catalyst material;

(d) reduce the quantity of cement; and/or

(e) reduce the quantity of coal fly ash.

If, for example, the measured reaction temperature is lower than a predetermined threshold temperature, control unit 99 can change one or more of the following parameters:

(a) lengthen to curing duration;

(b) increase the water temperature;

(c) increase the quantity of cement hardening catalyst material;

(d) increase the quantity of cement; and/or

(e) increase the quantity of coal fly ash.

Hence the curing process is a converging process, adaptive to environment conditions such as temperature and humidity.

Sixth station S6 may also include one or more sub stations for cutting the hardened parallelepiped lightweight construction body 60. For example, in a first cutting station body 60 is cut perpendicular to the floor surface and parallel to one side of body 60; in a second cutting station body 60 is cut perpendicular to the floor surface and perpendicular to the cut performed in the first cutting station; and in a third station, cutting station body 60 is sliced parallel to the floor surface.

In the preferred embodiment of the present invention, production line 500 further includes wrapping station S8 for wrapping the lightweight construction bricks with wrapping material. In other embodiments of the present invention wrapping the lightweight construction bricks with wrapping material is performed off production line 500. It should be noted the wrapped lightweight construction bricks 70 is left for a curing process for several hours, typically 24 hours. The wrapping material can be any material used in the industry, including plastic, nylon and coating with curing liquid.

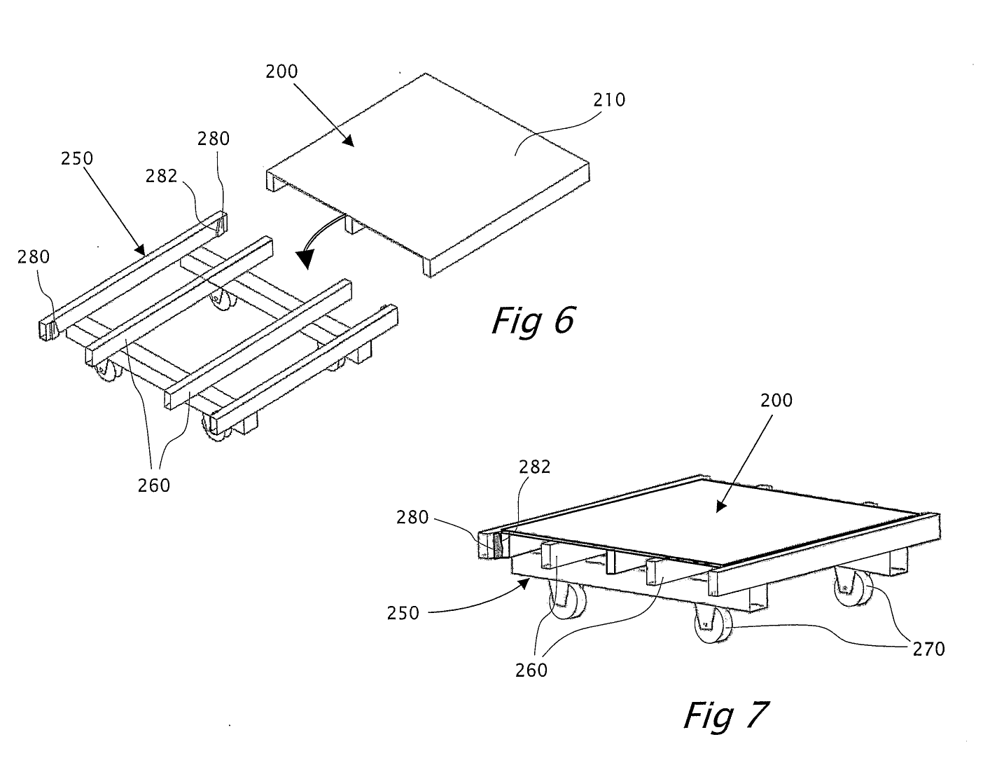

Mold 300 with or without lightweight construction material 50, cut or uncut hardened parallelepiped lightweight construction body 60, and wrapped lightweight construction bricks 70, are disposed on pallet 200 which is placed on some moving device. FIG. 6 illustrates the assembly of an example cart 250 and pallet 200 for conveying the lightweight bricks being manufacture in production line 500 shown in FIG. 5, and FIG. 7 illustrates cart 250 and pallet 200 assembled. Top surface 210 of pallet 200 is substantially flat and sealed. Typically mold 300 is laminated with a thin layer of non sticking material such as plastic thereby preventing water from mixture 50 to leak out of mold 300. Cart 250 includes a moving mechanism such as wheels 270 and supporting structure for pallet 200, such as crossbeams 260. Preferably, cart 250 further includes a mechanism for locking pallet 200 in place, such as parts 280. Parts 280 may include slope 282 to ease the sliding of pallet 200 into place.

Production line 500 further includes a mechanism for assembling mold 300 at second station S2, a mechanism for disassembling mold 300 at fifth station S5; a mechanism for transferring the disassembled mold 300 from station S5 to assembly station S2; and a mechanism for removing pallet 200 with the lightweight construction bricks from the production line, at final station S7. In the preferred embodiment of the present invention, the mechanism for disassembling mold 300 at fifth station S5, transferring the disassembled mold 300 from station S5 to assembly station S2 and assembling mold 300 at second station S2, are combined into one mechanism including a crane 520, which includes a lifting and descending mechanism 530. The pulling of mold 300 at fifth station S5 causes mold 300 to disassemble and thereby depart from lightweight construction body 60. The descending of mold 300 at second station S2 causes the walls of mold 300 to join together into a substantially sealed parallelepiped and simultaneously lock about pallet 200.

Preferably, production line 500 further includes station S0 for cleaning and/or oiling the disassembled mold 300, after moving the disassembled mold 300 from station S5 and moving disassembled mold 300 to assembly station S2.

The activities and processes in production line 500 are controlled by computerized control unit 99, which enables a fully automatic production of the lightweight construction bricks.

In embodiments of the present invention, production line 500 operates in an independent form and is supplied with ready-to-use mixture 50 of construction material from an external source, and not directly from system 100 for producing ready-to-use uniform mixtures 50 of lightweight construction materials. When operating in an independent form, production line 500 includes an independent computerized control unit for controlling all activities and processes in production line 500.

### A Mold for Producing Ready-to-Ship Porous Lightweight Brick Walls

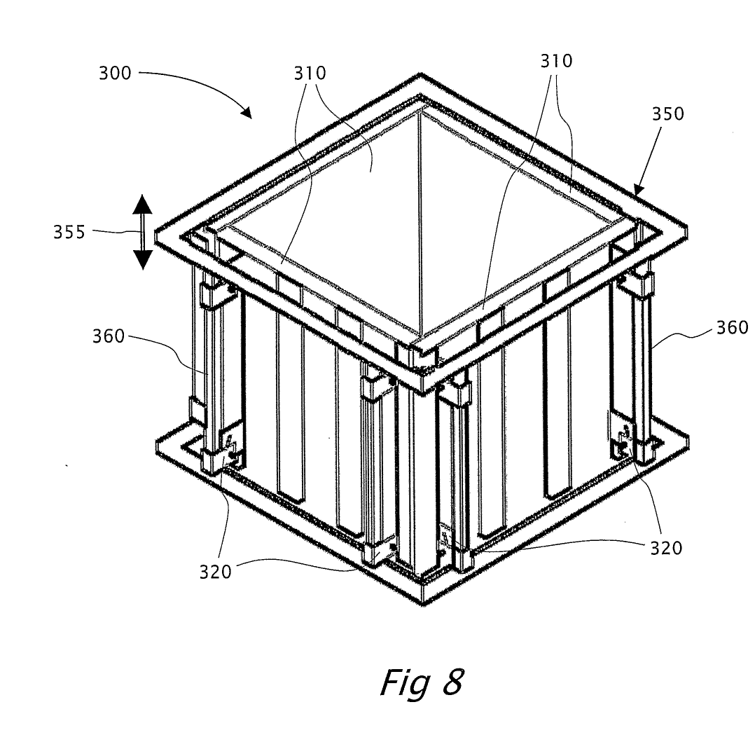

FIG. 8 illustrates an example mold 300 for producing ready-to-ship porous lightweight brick walls, according to embodiments of the present invention. Mold 300 includes four walls 310 that can move in and out with respect to the central axis of mold 300, locking mechanisms 320 and a structure 350 including vertical bars 360. When structure 350 is pulled up in direction 355, vertical bars 360 operatively unlock respective locking mechanisms 320, thereby walls 310 move outwardly with respect to the central axis of mold 300. When structure 350 is descended in direction 355, vertical bars 360 operatively lock respective locking mechanisms 320, thereby walls 310 move inwardly with respect to the central axis of mold 300, and join together into a substantially sealed parallelepiped.

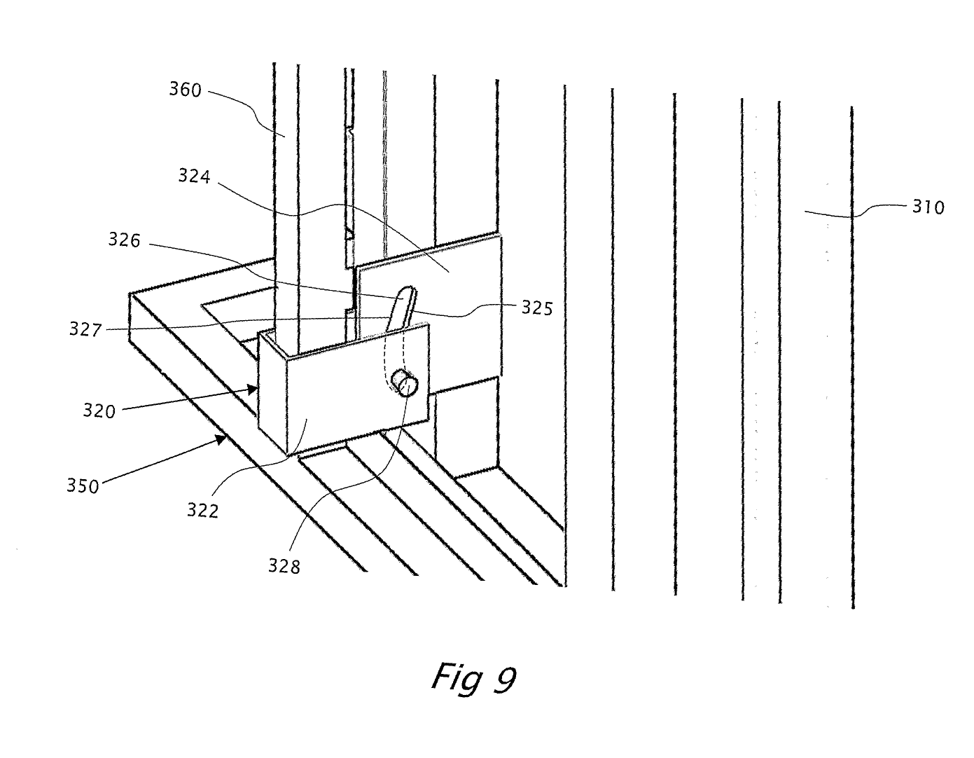

Each wall 310 has at least one locking/unlocking mechanism 320. FIG. 9 illustrates an example locking/unlocking mechanism 320 of walls 310 of mold 300. Locking mechanism 320 includes a part 324 which is affixed to the outside surface of wall 310, a pin 328 and an interface part 322 which is operatively engaged with bars 360 of structure 350. Affixed part 324 includes a generally diagonal groove 326, into which pin 328, being affixed to interface part 322, is inserted. The upper side of diagonal groove 326 is closer to wall 310 and the lower part of diagonal groove 326 is more distal from wall 310, with respect to the upper side of diagonal groove 326.

When bar 360 is forcefully lifted in the upward direction (355), structure 350 pulls up interface part 322 including pin 328. Pin 328 applies outwardly force on inner surface 327 of groove 326, thereby forcing part 324 to move outwardly with respect to the central axis of mold 300, and thereby also forcing wall 310, being affixed to part 324, to move outwardly with respect to the central axis of mold 300. When pin 328 reaches the upper end of groove 326, mold 300 is lifted being in an open state.

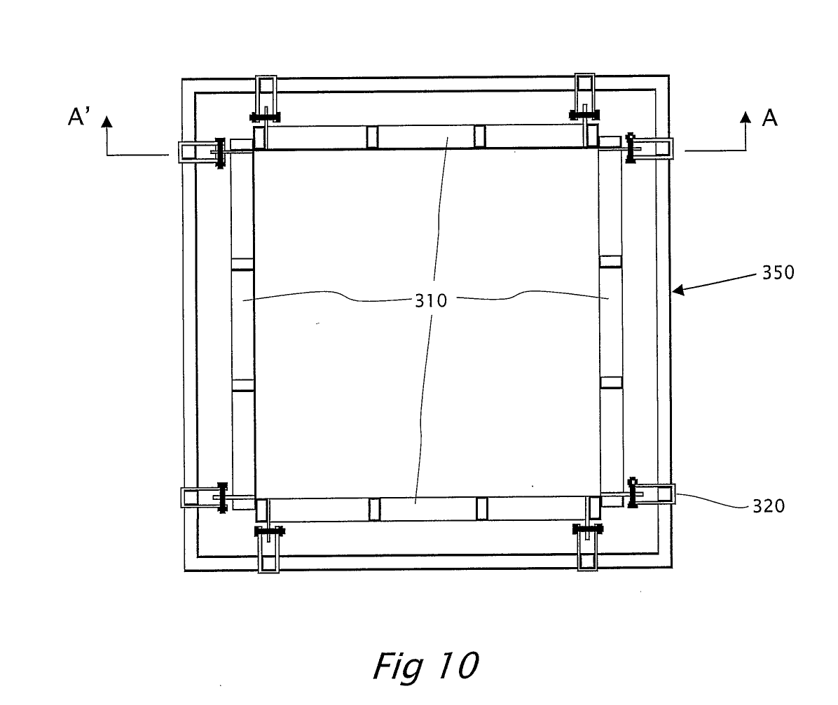

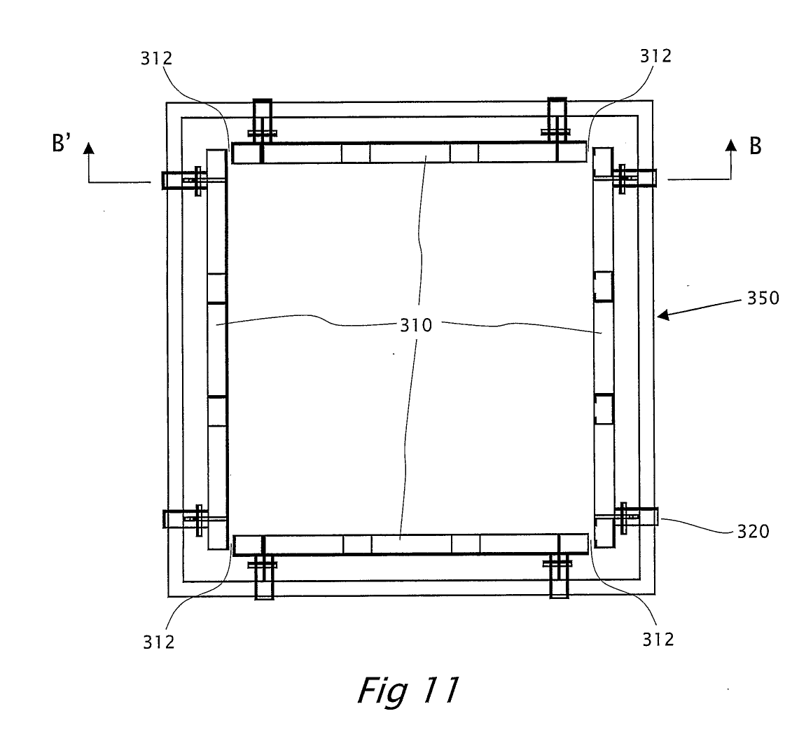

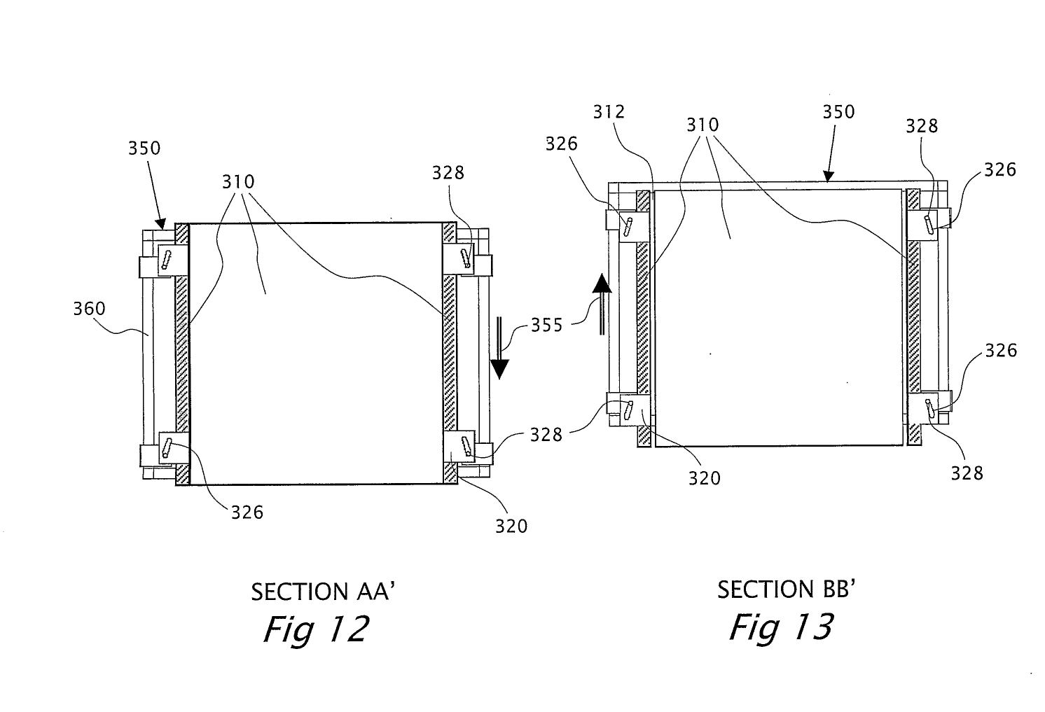

When mold 300 is in a lifted position and thereby in an unlocked state, and the lifting mechanism 530 start descending mold 300, mold 300 reaches the upper surface of a flat, rigid surface. Typically, in production line 500, mold 300 reaches the upper surface of supporting bars 260 of cart 250, generally around pallet 200. After reaching a rigid surface, the weight of structure 350 pulls down interface part 322 including pin 328. Pin 328 applies inwardly force on inner surface 325 of groove 326, thereby forcing part 324 to move inwardly with respect to the central axis of mold 300, and thereby also forcing wall 310, being affixed to part 324, to move inwardly with respect to the central axis of mold 300. All four walls 310 move together, forcefully joining together, to form a substantially sealed parallelepiped. When pin 328 reaches the lower end of groove 326, mold 300 is in a locked state. Groove 326 is preferably not a straight groove but rather arched inwardly with respect to wall 310, thereby enabling a more stable locking of walls 310. FIG. 10 illustrates a top view illustration of mold 300, mold 300 being in a locked state. FIG. 11 illustrates a top view illustration of mold 300, mold 300 being in an open state. When mold 300 is in an open state, a gap 312 is formed between adjacent walls. FIG. 12 illustrates cross section AA′ of the mold 300, mold 300 being in a locked state. FIG. 13 illustrates cross section BB′ of the mold 300, mold 300 being in an open state.

It should be noted that ready-to-use mixture 50 of lightweight construction material manufacturing can be used for brick walls having specific weight/gravity of less than 700 Kg/m³. It should be further noted that ready-to-use mixture 50 of lightweight construction material manufacturing can be used for manufacturing pavement bricks having specific weight/gravity of less than 1600 Kg/m³.

In embodiments of the present invention, one or more containers include a sensor that measures the level of material in the container, and reports the measured level to computerized control unit 99.

In embodiments of the present invention one or more material ingredients are added from post mixer container 168 to mixture 50 flowing out of mixer 150. Typically, post mixer container 168 contains fibers, which are added to poring mixture 50, for example, polypropylene fibers.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

1-35. (canceled)

36. A system for producing ready-to-use mixtures of lightweight construction materials having predetermined specifications, the system comprising:
(a) one or more containers containing dry construction materials;
(b) a mechanism for moving the dry construction materials;
(c) one or more containers containing additive materials controllably added to said ready-to-use mixture of lightweight construction material;
(d) water supply subsystem;
(e) pressured air supplying unit;
(f) a foaming canon;
(g) a moistening unit;
(h) a main mixer; and
(i) a computerized control unit,
wherein pre measured quantities of said dry construction materials are mixed and pushed into said moistening unit and pre measured amount of water are propagated into said moistening unit, and wherein said dry construction materials and said water are mixed together by said moistening unit, thereby producing wet mortar having a controlled amount of moisture;
wherein pre measured quantities of said additive materials are propagated into said foaming canon and pre measured amount and pressure of air is propelled into said foaming canon, and wherein said additive materials and said air are mixed together by said foaming canon, thereby producing a controlled foam having controlled quantity and size of air bubbles;
wherein pre measured quantities of said wet mortar and pre measured quantities of said controlled foam are propelled into said main mixer thereby producing said ready-to-use mixture of lightweight construction material having a controlled specific gravity and a substantially uniform texture; and
wherein said produced ready-to-use mixture of lightweight construction material is analyzed by said control unit whereas, if needed, said control unit adjusts one or more controllable system parameters, whereby said produced ready-to-use mixture of lightweight construction material attains said specifications.

37. The system as in claim 36, wherein said dry construction materials are selected from the group including: cement, coal fly ash, ground sand and other dry construction materials.

38. The system as in claim 36, wherein said container containing dry construction materials contains a substantially uniform mixture of dry construction materials selected from the group including: cement, coal fly ash, ground sand and other dry construction materials.

39. The system as in claim 36, further comprising a blower, wherein said blower pushes said dry construction materials.

40. The system as in claim 36, wherein said additive materials are selected from the group including: cement hardening catalyst materials, detergents, polymers and other additive materials.

41. The system as in claim 40, wherein one of said polymer is Styrene Butadiene Rubber (SBR).

42. The system as in claim 40, wherein one of said cement hardening catalyst materials is Calcium Chloride.

43. The system as in claim 36, wherein said control unit controls parameters of the system, wherein said parameters are selected from a group including: the quantity of materials in one or more of said containers, the temperature volume and flow rate of said water channeled to said moistening unit, the temperature volume and flow rate of said water channeled to said foaming canon, the pressure and volume of said air propelled into said foaming canon, said volume and flow rate of each of said dry construction materials, said volume and flow rate of each of said additive materials, said volume and flow rate of said wet mortar, and said volume and flow rate of said controlled foam.

44. The system as in claim 40, wherein said detergent enables the formation of air bubbles in said ready-to-use mixture of lightweight construction material.

45. The system as in claim 36, wherein said water supply subsystem comprises a water source selected from a group including: a water tank, public water supply network and any other water source.

46. The system as in claim 45, further comprising a water storage and heating device.

47. The system as in claim 46, wherein the heating energy used by said water storage and heating device is selected from the group including electric, solar, fuel, and any other source of energy.

48. The system as in claim 36 further comprising a post mixer container disposed at the outlet of said main mixer, wherein said post mixture container contains ingredients that are added to the mixture flowing out of said main mixer.

49. The system as in claim 48, wherein said post mixer container contains polymers.

50. The system as in claim 36, further comprising:
(a) a bricks production line for producing ready-to-ship lightweight construction bricks from said ready-to-use mixture of lightweight construction material, said bricks production line comprising:
i) a first station for placing a pallet;
ii) a second station for assembling a substantially parallelepiped mold, wherein said mold is opened at the bottom and top, and wherein said pallet is disposed at the bottom of said mold and thereby substantially sealing the bottom of said mold;
iii) a third station for filling said mold with said ready-to-use mixture of lightweight construction material;
iv) a fourth station for said ready-to-use mixture of lightweight construction material to complete the curing process and thereby hardening said lightweight construction material to create a hardened parallelepiped lightweight construction body;
v) a fifth station for disassembling said mold from said hardened parallelepiped lightweight construction body;
vi) a sixth station for cutting said hardened parallelepiped lightweight construction body into lightweight construction bricks; and
vii) a final station for removing said pallet with said lightweight construction bricks from the production line;
(b) a mechanism for assembling said mold at said second station;
(c) a mechanism for disassembling said mold at said fifth station;
(d) a mechanism for transferring said disassembled mold from said fifth station to said second station; and
(e) a mechanism for removing said pallet with said lightweight construction bricks from the production line, at said final station.

51. A bricks production line for producing ready-to-ship lightweight construction bricks from ready-to-use mixture of lightweight construction material, said bricks production line comprising:
(a) a control unit;
(b) a first station for placing a pallet;
(c) a second station for assembling a substantially parallelepiped mold, wherein said mold is opened at the bottom and top, wherein said pallet is disposed at the bottom of said mold and thereby substantially sealing the bottom of said mold;
(d) a third station for filling said mold with said ready-to-use mixture of lightweight construction material;
(e) a fourth station for said ready-to-use mixture of lightweight construction material to complete the curing process and thereby hardening said lightweight construction material to create a hardened parallelepiped lightweight construction body;
(f) a fifth station for disassembling said mold from said hardened parallelepiped lightweight construction body;
(g) a sixth station for cutting said hardened parallelepiped lightweight construction body into lightweight construction bricks; and
(h) a final station for removing said pallet with said lightweight construction bricks from the production line;
(i) a mechanism for assembling said mold at said second station;
(j) a mechanism for disassembling said mold at said fifth station;
(k) a mechanism for transferring said disassembled mold from said fifth station to said second station; and
(l) a mechanism for removing said pallet with said lightweight construction bricks from the production line, at said final station.

52. The production line as in claim 50, wherein said second station and said third station are the same station, wherein said filling of said mold with said ready-to-use mixture of lightweight construction material is performed after said assembly of said mold.

52. The production line as in claim 50, wherein said forth station includes one or more stations for controlling said curing process of said lightweight construction material.

54. The production line as in claims 50, wherein the temperature of said hardened parallelepiped lightweight construction body is measured at said fifth station, wherein said measured temperature is transmitted to said control unit, and wherein said control unit analyzes said measured temperature.

55. The production line as in claim 54, wherein when said measured temperature is above a predetermined threshold temperature, said control unit performs at least one of the following steps:
(a) shorten the curing duration;
(b) reduce the water temperature;
(c) reduce the quantity of cement hardening catalyst material;
(d) reduce the quantity of cement; and
(e) reduce the quantity of coal fly ash.

56. The production line as in claim 54, wherein when said measured temperature is below a predetermined threshold temperature, said control unit performs at least one of the following steps:
(a) lengthen the curing duration;
(b) increase the water temperature;
(c) increase the quantity of cement hardening catalyst material;
(d) increase the quantity of cement; and
(e) increase the quantity of coal fly ash.

57. The production line as in claim 50, wherein said sixth station includes one or more stations for cutting said hardened parallelepiped lightweight construction body.

58. The production line as in claim 50 further comprising a station for wrapping said lightweight construction bricks.

59. The production line as in claim 50, wherein said control unit enables a fully automatic production of said lightweight construction bricks.

60. The system as in claim 50, wherein said substantially parallelepiped mold comprises:
(a) four walls;
(b) a mechanism for locking said four walls together when assembling said mold at said second station, and thereby substantially sealing said four walls; and
(c) a mechanism for unlocking said four walls when disassembling said mold at said fifth station, without damaging said hardened parallelepiped lightweight construction body.

61. The system as in claim 50, wherein said mechanism for assembling said mold at said second station is a crane.

62. The system as in claim 50, wherein said mechanism for disassembling said mold at said fifth station is a crane.

63. The system as in claim 50, wherein said mechanism for transferring said disassembled mold from said fifth station to said second station is a crane.

64. The system as in claim 50, wherein said mechanism for assembling said mold at said second station, and said mechanism for disassembling said mold at said fifth station, and said mechanism for transferring said disassembled mold from said fifth station to said station second station are the same mechanism.

65. The system as in claim 50, wherein said mechanism for assembling said mold at said second station and said mechanism for disassembling said mold at said fifth station are controlled by said control unit.

66. The production line as in claim 50, wherein said curing process for hardening said lightweight construction material is controlled by said control unit.

67. The production line as in claim 50, wherein said controlled chemical reaction for hardening said lightweight construction material prevents the cracking of said lightweight construction bricks.

68. The production line as in claim 50, wherein the scheduling of the activities at each of said stations is controlled by said control unit.

69. The production line as in claim 50, wherein the number of stations is designed according to the volume of lightweight construction bricks produced.
